(19) United States
(12) Patent Application Publication
(10) Pub. No.: US 2007/0124907 A1
(43) Pub. Date: Jun. 7, 2007

(54) Split-sleeve heater and removal tool

(75) Inventors: Elias Russegger, Golling (AT); Gerhard Schefbanker, Golling (AT); Gernot Antosch, Hallein (AT); Wolfgang Poschl, Abtenau (AT); Reinhardt Lehnert, Ubstadt-Weiher (DE); Kevin Ptasienski, O'Fallon, MO (US)

Correspondence Address: HARNESS, DICKEY & PIERCE, P.L.C., P.O. BOX 828, BLOOMFIELD HILLS, MI, 48303, US

(73) Assignee: Watlow Electric Manufacturing Company, St. Louis, MO (US)

(21) Appl. No.: 11/602,707

(22) Filed: Nov. 21, 2006

Related U.S. Application Data
(60) Provisional application No. 60/742,156, filed on Dec. 2, 2005.

(51) Int. Cl. B23P 19/00

(52) U.S. Cl. 29/426.1; 29/242

(57) ABSTRACT

A tool for removing a split-sleeve heater from a target object, such as a hot runner nozzle body, is provided that includes a handle, a shaft extending from the handle, and a protrusion disposed around at least a portion of a distal end portion of the shaft. The protrusion defines a shoulder, and the shoulder is adapted to engage a removal feature of the split-sleeve heater. In another form, a split-sleeve heater is provided that includes a heater body having opposed ends and a slot extending between the opposed ends. A recess is formed conjointly with the slot proximate at least one of the opposed ends, which is adapted for engagement by a removal tool. Methods of operating the tool and forming the slot of the split-sleeve heater are also provided.

### FIELD

The present disclosure relates to split-sleeve heaters and more particularly to a tool for removing split-sleeve heaters from target objects, such as hot runner nozzles, which are subjected to extreme thermal conditions of repeated heating and cooling.

### BACKGROUND

The statements in this section merely provide background information related to the present disclosure and may not constitute prior art.

Many applications exist in which it is desirable to replace a sleeve or other device that is fit onto the outer periphery of another object. Removal of the sleeve or other device is often painstaking due to certain environmental conditions such as repeated heating and cooling cycles. Additionally, removal can cause damage to both the sleeve or other device and the object around which it is disposed. Removal can also involve a significant amount of labor and could result in the need to repair or completely replace each of the parts.

One such application is that of a heater having a generally cylindrical bore that is closely fit onto a hot runner nozzle of injection molding equipment. The heater generally maintains a close fit with the nozzle and thus provides good thermal conductivity between the heater and the nozzle body. It is well known that during the operation of the injection molding equipment, the nozzle heater may burn out. Hot runner nozzle heaters are also exposed to repeated heating and cooling which can cause the heater to become lodged onto the nozzle body. Also, contamination that may have accumulated between the heater and the nozzle body during operation can cause removal of the heater to be time consuming and costly, which ultimately impacts productivity of the injection molding equipment. Often, the heater cannot be removed without damaging the nozzle body, which reduces the life of the nozzle body and increases the costs of injection molding operations. Likewise, it may be necessary to replace the nozzle body, but not the heater device. Removal of the nozzle body could likely damage the heater, which reduces the life of the heater and also increases the cost of injection molding operation.

### SUMMARY

In one form, a tool for removing a split-sleeve heater from a target object is provided that comprises a handle and a shaft extending from the handle, wherein the shaft defines a distal end portion. The tool further comprises a protrusion disposed around at least a portion of the distal end portion of the shaft, and the protrusion is adapted to engage a removal feature of the split-sleeve heater. Preferably, the protrusion defines a shoulder to engage the removal feature, and the shaft defines a tapered end portion to aid in engaging a slot of the split-sleeve heater. Additionally, an alternate slide hammer is provided that is operatively engaged with the handle to aid in removing the split-sleeve heater.

In another form, a split-sleeve heater is provided that comprises a heater body comprising opposed ends and a slot extending between the opposed ends. A removal feature is disposed adjacent the slot proximate at least one of the opposed ends. Preferably, the removal feature comprises a recess formed conjointly with the slot proximate at least one of the opposed ends.

In yet another form, a method of removing a split-sleeve heater from a target object is provided that comprises placing a removal tool within a slot of the split-sleeve heater, sliding the removal tool along the slot, engaging a distal end of the removal tool with a recess formed conjointly with the slot, and pulling the removal tool in a proximal direction. Preferably, the method further comprises rotating the removal tool after sliding the removal tool along the slot to engage the removal tool with the recess. In an alternate method, the pulling further comprises use of a slide hammer.

In still another form, a method of forming a slot for a split-sleeve heater is provided that comprises placing the split-sleeve heater around an inner mandrel, the inner mandrel defining a groove extending along a length of the inner mandrel, placing an outer mandrel around the split-sleeve heater, the outer mandrel defining a groove extending along a length of the outer mandrel, positioning the groove of the outer mandrel opposite the groove of the inner mandrel, placing a cutting device within the grooves of the outer mandrel and the inner mandrel, and removing a portion of the split-sleeve heater positioned between the grooves of the outer mandrel and the inner mandrel to form a slot therein.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a hot runner nozzle body and a split-sleeve heater adapted for placement around the hot runner nozzle body constructed in accordance with the principles of the present disclosure;

FIG. 2 is a perspective view of a split-sleeve heater installed around a hot runner nozzle body and constructed in accordance with the principles of the present disclosure;

FIG. 3 is an enlarged perspective view of a removal feature of the split-sleeve heater and constructed in accordance with the principles of the present disclosure;

FIG. 4 is a perspective view of a removal tool constructed in accordance with the principles of the present disclosure;

FIG. 5a is an enlarged top view of the protrusion of the removal tool constructed in accordance with the principles of the present disclosure;

FIG. 5b is an enlarged side view of the protrusion and constructed in accordance with the principles of the present disclosure;

FIG. 5c is an enlarged end view of the protrusion and constructed in accordance with the principles of the present disclosure;

FIG. 6 is a side view of the removal tool in accordance with the principles of the present disclosure;

FIG. 7 is a side view, rotated 90 degrees from FIG. 6, of the removal tool in accordance with the principles of the present disclosure;

FIG. 8 is a side view, rotated 90 degrees from FIG. 7, of the removal tool in accordance with the principles of the present disclosure;

FIG. 9 is a side view, rotated 90 degrees from FIG. 8, of the removal tool in accordance with the principles of the present disclosure;

FIG. 10 is a perspective view of the split-sleeve heater constructed in accordance with the principles of the present disclosure;

FIG. 11 is an end view of the split-sleeve heater constructed in accordance with the principles of the present disclosure;

FIG. 12 is an enlarged detail view of the slot of the split-sleeve heater constructed in accordance with the principles of the present disclosure;

FIG. 13 is a perspective view of the mandrels used to form the slot within the split-sleeve heater and constructed in accordance with the principles of the present disclosure;

FIG. 14 is a top view of the split-sleeve heater disposed between the mandrels to form the slot in accordance with the principles of the present disclosure;

FIG. 15 is a front view of a split-sleeve heater disposed around a target object and constructed in accordance with the principles of the present disclosure;

FIG. 16 is a front view of the removal tool engaging a slot of the split-sleeve heater in accordance with the principles of the present disclosure;

FIG. 17 is a front view of the removal tool positioned to engage a recess of the split-sleeve heater in accordance with the principles of the present disclosure;

FIG. 18 is a front view of the removal tool engaging the recess of the split-sleeve heater in accordance with the principles of the present disclosure;

FIG. 19 is a front view of the removal tool with the split-sleeve heater removed from the target object in accordance with the principles of the present disclosure;

FIG. 20a is a cross-sectional view of the shaft of the removal tool within the slot of the split-sleeve heater and constructed in accordance with the principles of the present disclosure;

FIG. 20b is a cross-sectional view of the shaft of the removal tool, rotated 90 degrees from FIG. 20a, illustrating removal of the tool from within the slot of the split-sleeve heater in accordance with the principles of the present disclosure; and

FIG. 21 is a side cross-sectional view of an alternate form of the removal tool having a slide hammer and constructed in accordance with the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

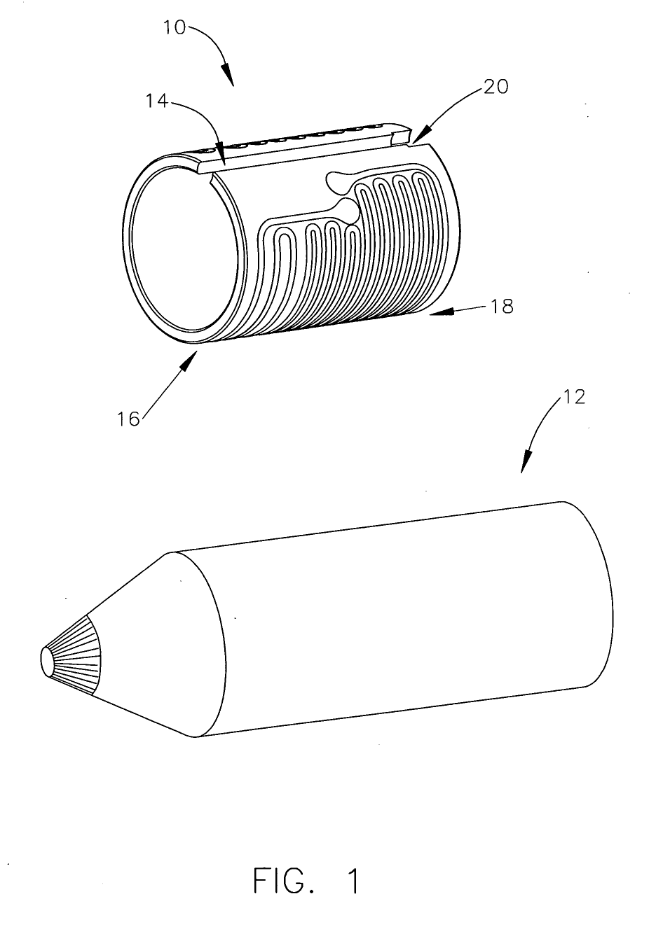

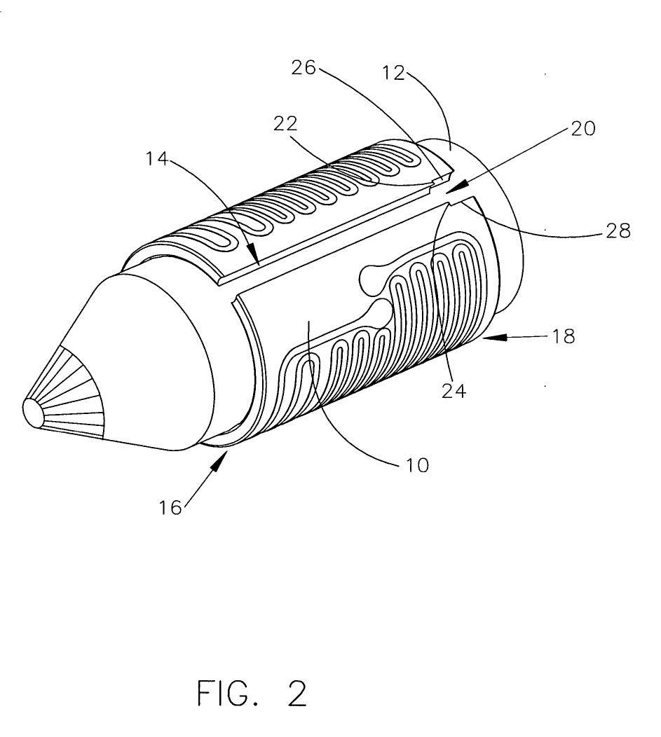

Referring to FIGS. 1 through 3, a split-sleeve heater 10 is illustrated, along with a target object 12, wherein the split-sleeve heater 10 is adapted for placement around the target object 12. In one application, the target object 12 is a hot runner nozzle body as illustrated, which is an integral part of injection molding equipment, and which undergoes extreme temperature variations throughout its operation thus making removal of a heater quite challenging.

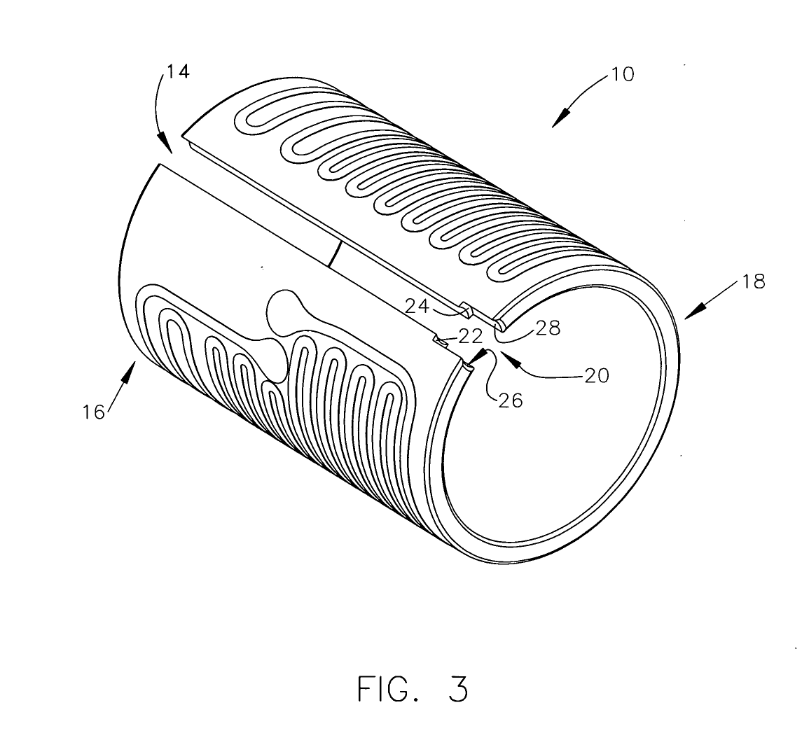

To facilitate removal, the split-sleeve heater 10 comprises a slot 14 that extends along its length between opposed ends 16 and 18 as shown. As illustrated in greater detail in FIG. 3, a removal feature in the form of a recess 20 is formed conjointly with the slot 14 proximate one of the opposed ends 18. The recess 20 comprises upper walls 22 and 24 and extended side walls 26 and 28 to form a generally rectangular configuration. However, other geometrical configurations for the recess 20 may be employed while remaining within the scope of the present disclosure. For example, the recess 20 may have only one upper wall 22 and one extended side wall 26 such that the recess 20 is only on one side of the slot 14. In the variety of possible geometries, the recess 20 is adapted for engagement by a removal tool of the present disclosure, which is described in greater detail below.

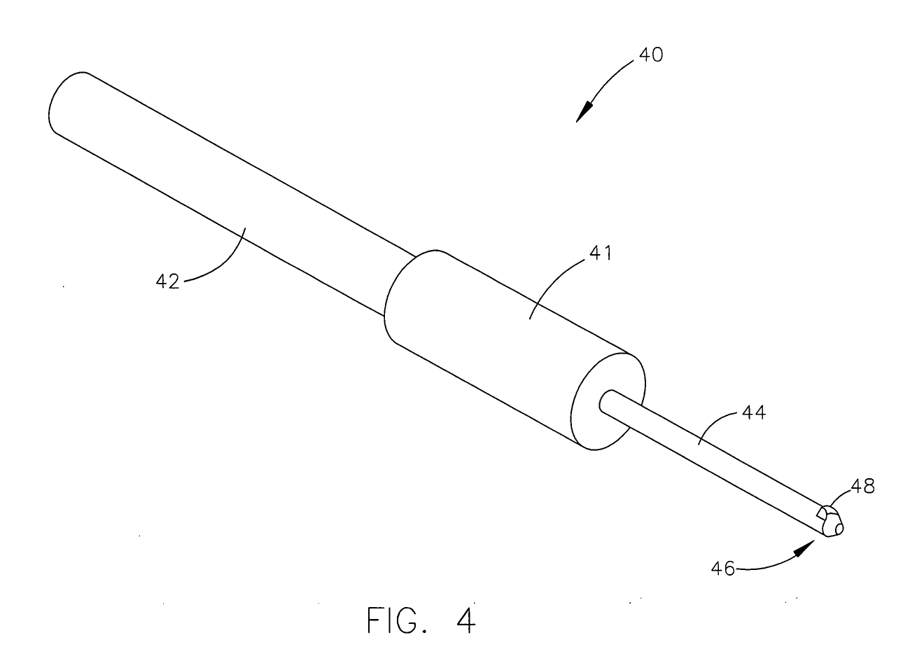

As shown in FIG. 4, a removal tool in accordance with one form of the present disclosure is illustrated and generally indicated by reference numeral 40. The removal tool 40 comprises a handle 42 and a shaft 44 extending from the handle 42 as shown. Additionally, the handle 42 comprises a proximal collar 41 as shown in one preferred form to facilitate pulling of the removal tool 40 as described in greater detail below. The shaft 44 defines a distal end portion 46, which is adapted for engagement with the removal feature of the split-sleeve heater 10. More specifically, a protrusion 48 is disposed around at least a portion of the distal end portion 46 of the shaft 44, wherein the protrusion 48 is adapted for engagement of the removal feature of the split-sleeve heater 10.

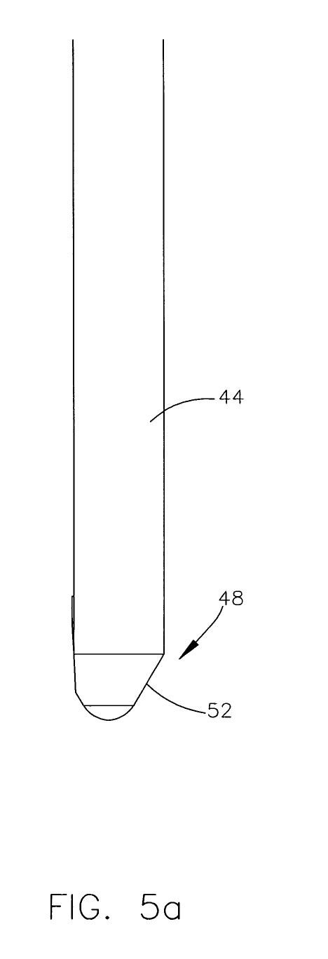

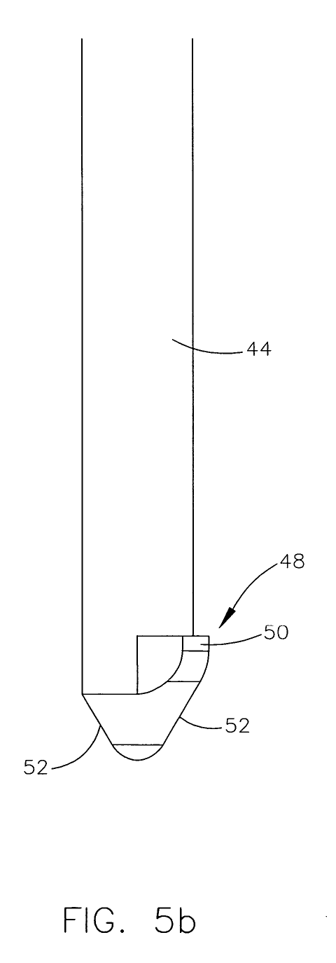

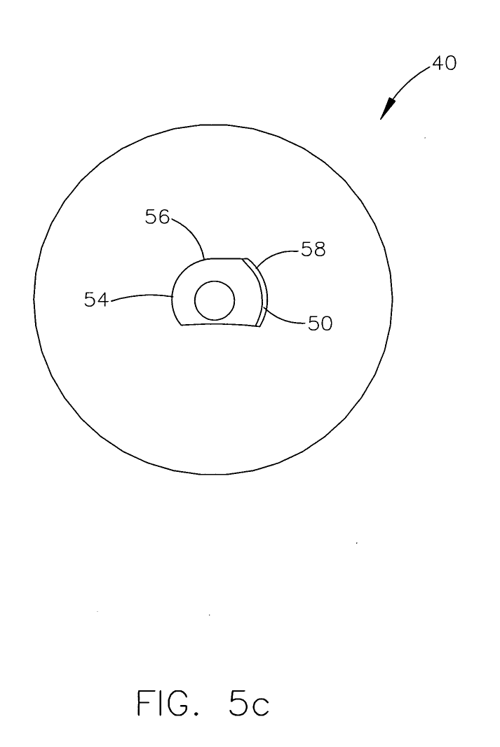

Referring to FIGS. 5a through 5c, the protrusion 48 preferably defines a shoulder 50 and the shaft preferably defines a tapered end portion 52 to engage the recess 20 and the slot 14, respectively, of the split-sleeve heater 10, which is described in greater detail below. In one form of the present disclosure, the shoulder 50 of the protrusion 48 does not extend around the entire periphery of the distal end portion 46 of the shaft 44 and preferably extends around less than 90 degrees of the periphery of the shaft 44 as shown in FIG. 4c. Accordingly, the distal end portion 46 of the shaft 44 defines blended surfaces 54 and 56 that adjoin an outer surface 58 of the shoulder 50.

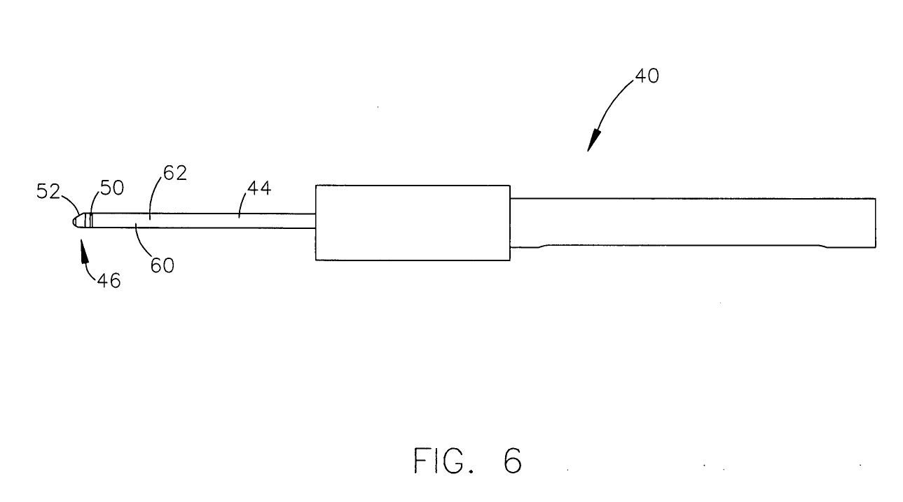

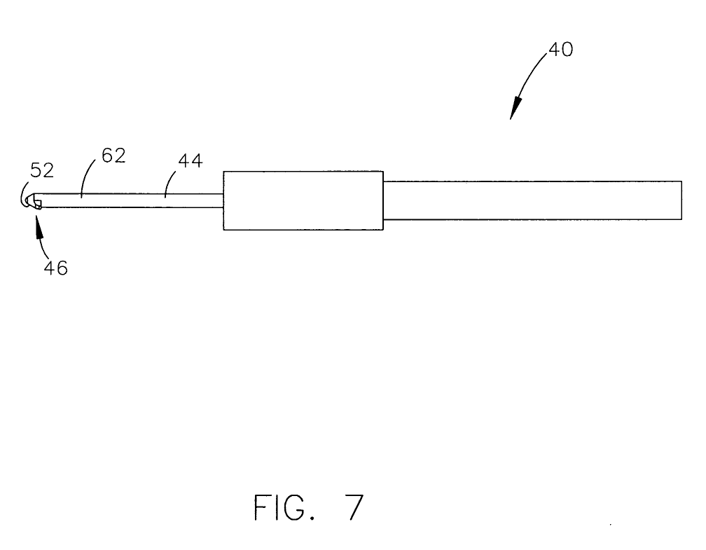

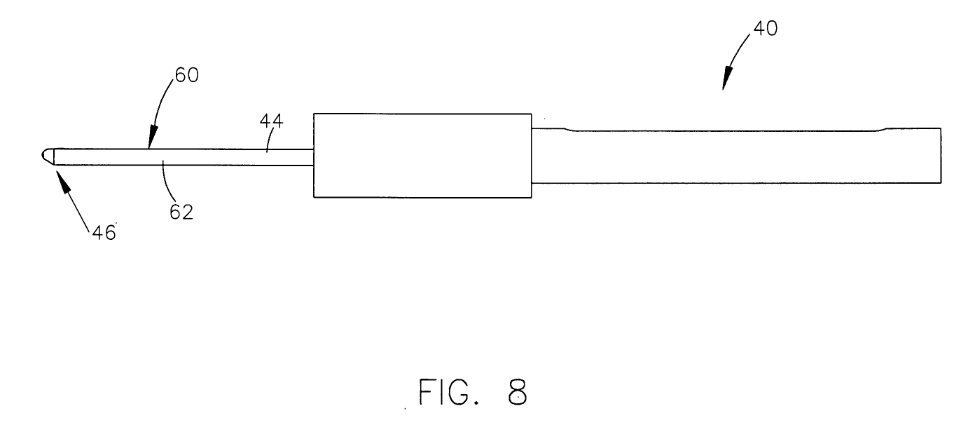

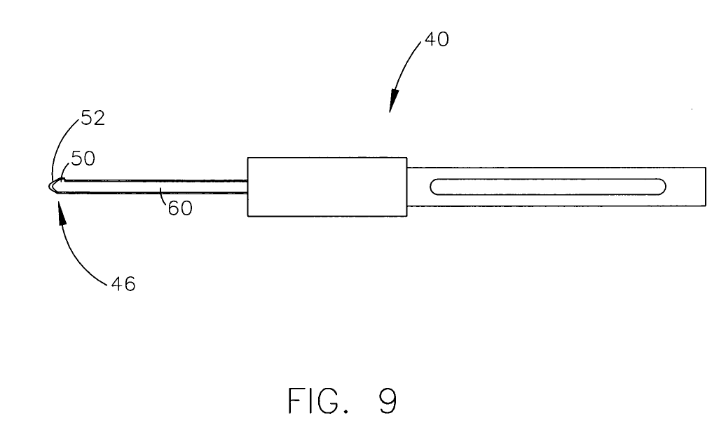

As shown in FIGS. 6 through 9, the shaft 44 defines a semi-cylindrical shape that comprises a flat face 60 and an arcuate face 62, which are joined along a length L of the shaft 44 as shown at edges 61 and 63. The flat face 60 preferably extends all the way to the distal end portion 46 of the shaft 44, thus extending across the shoulder 50 and the tapered end portion 52. The arcuate face 62, which is preferably cylindrical, preferably extends to the shoulder 50 and across the blended surfaces 54 and 56. Accordingly, this combination of faces and surfaces cooperatively engage features of the slot 14 of the split-sleeve heater 10 to facilitate ease of removal.

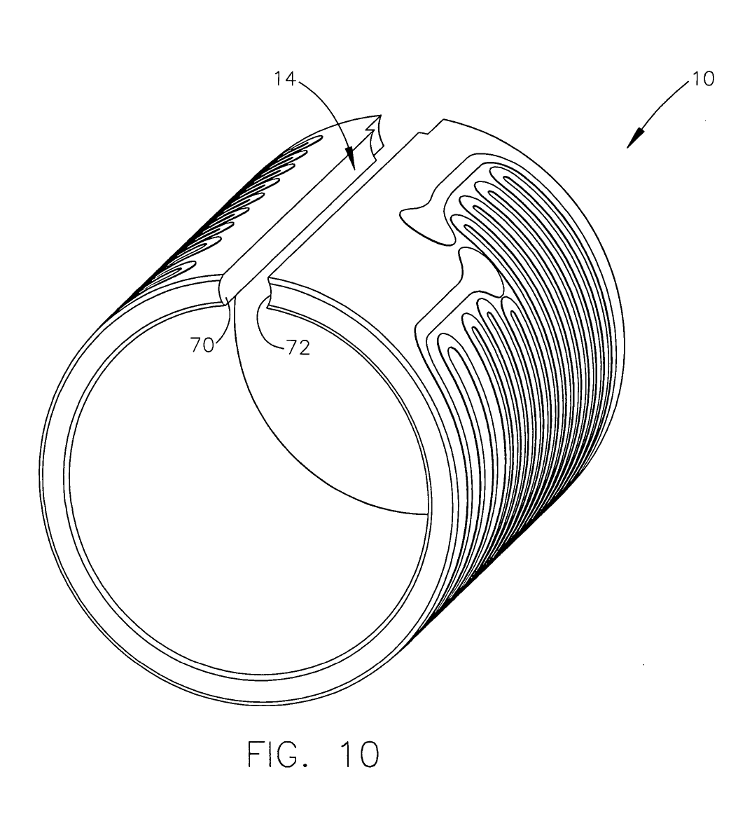

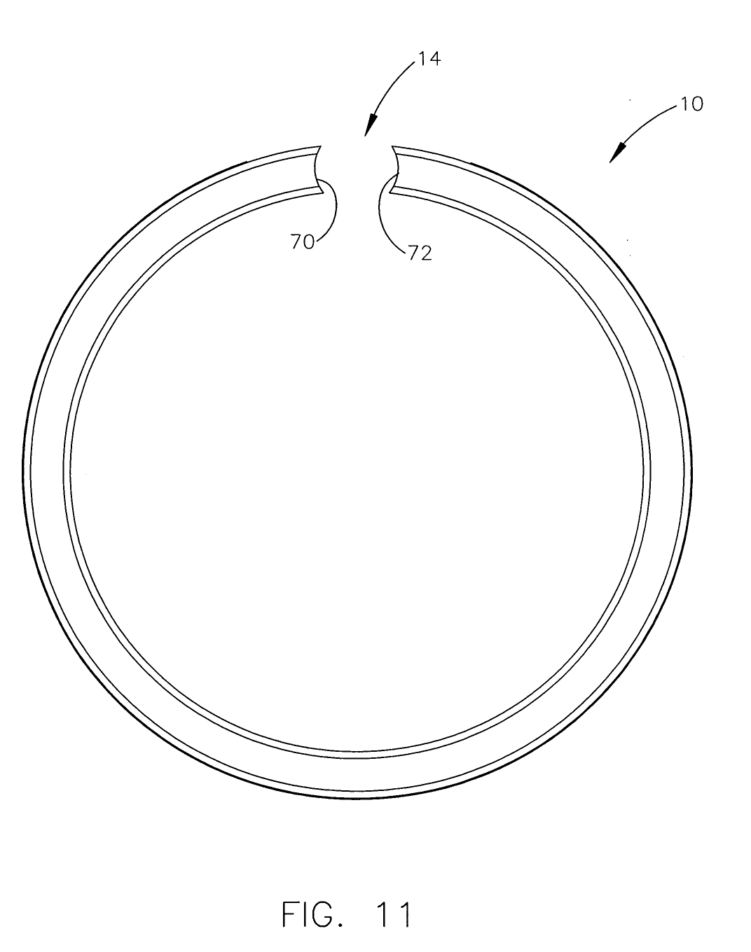

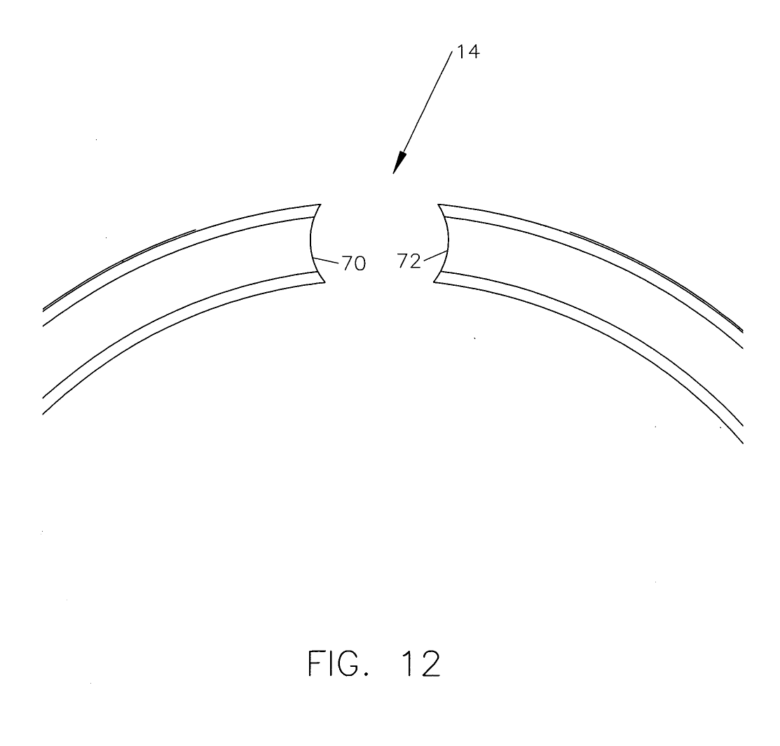

Referring now to FIGS. 10 through 12, the split-sleeve heater 10 preferably defines a cylindrical shape as shown, although it should be understood that other shapes may be employed for the split-sleeve heater 10 while remaining within the scope of the present disclosure. Additional details of the split-sleeve heater 10 include, but are not limited to, those as disclosed in co-pending application Ser. No. 11/252,198, titled “Hot Runner Nozzle Heater and Methods of Manufacture Thereof,” filed Oct. 17, 2005, which is commonly assigned with the present application and the entire contents of which are incorporated by reference herein in their entirety.

As further shown, the slot 14 of the split-sleeve heater 10 defines curved walls 70 and 72 preferably extending along the entire length of the slot 14. The curved walls 70 and 72 are adapted for cooperative engagement with the faces and surfaces of the shaft 44, as previously described, during operation of the removal tool 40.

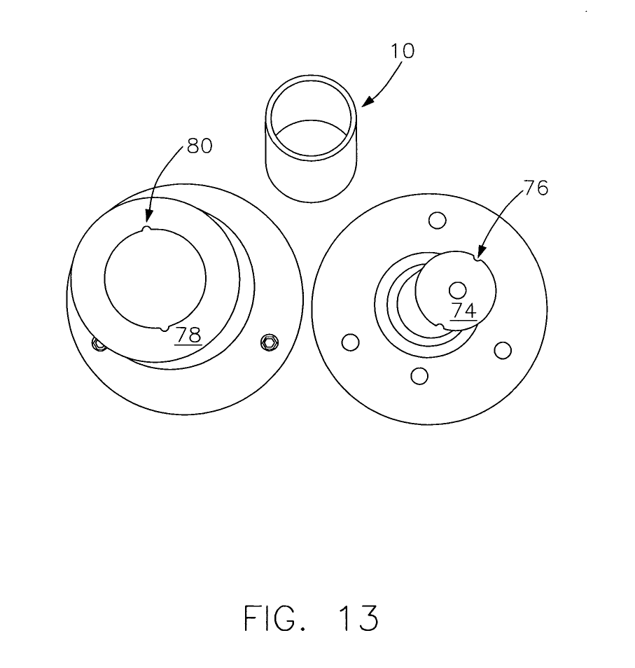

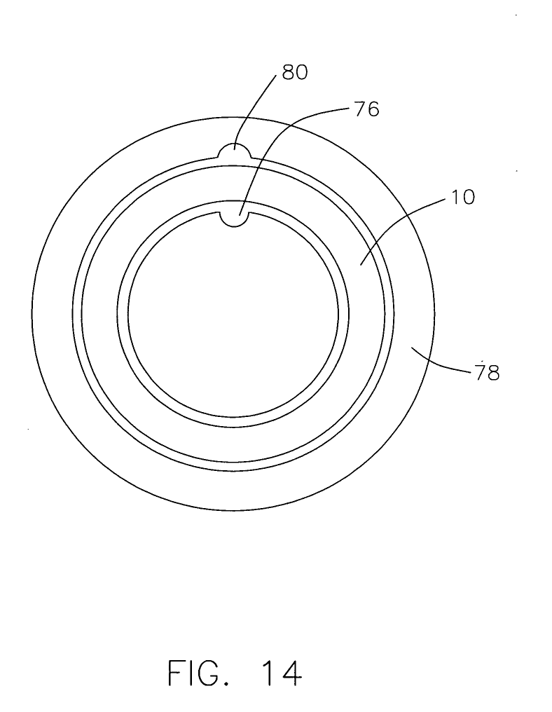

To form the curved walls 70 and 72, a set of mandrels are employed as illustrated in FIGS. 13 and 14. The mandrels preferably include an inner mandrel 74, which defines at least one groove 76 extending along the length of the inner mandrel 74. An outer mandrel 78 is also provided, which similarly defines at least one groove 80 extending along the length of the outer mandrel 78. To form the slot 14 with curved walls 70 and 72, the split-sleeve heater 10 (or a substrate that is used to form the heater) is first placed around the inner mandrel 74. The outer mandrel 78 is then placed around the split-sleeve heater 10, and the groove 80 of the outer mandrel 78 is positioned opposite the groove 76 of the inner mandrel 74 as shown. Preferably, the respective diameters of the inner mandrel 74, the heater 10, and the outer mandrel 78 are sized such that their fit when placed together as shown in FIG. 14 is relatively close or snug.

Next, a cutting device such as a drill bit (not shown) is placed within the grooves 80 and 76 and operated to remove a portion of the split-sleeve heater 10 disposed between the grooves 80 and 76 of the outer mandrel 80 and the inner mandrel 74, respectively, thus forming the slot 14. It should be understood that other cutting devices and methods, such as a laser by way of example, may be employed to form the curved walls 70 and 72 while remaining within the scope of the present disclosure.

In another preferred form, the inner mandrel 74 and the outer mandrel 78 comprise a plurality of grooves 76 and 80, respectively, of varying size to create slots of various sizes.

Operation

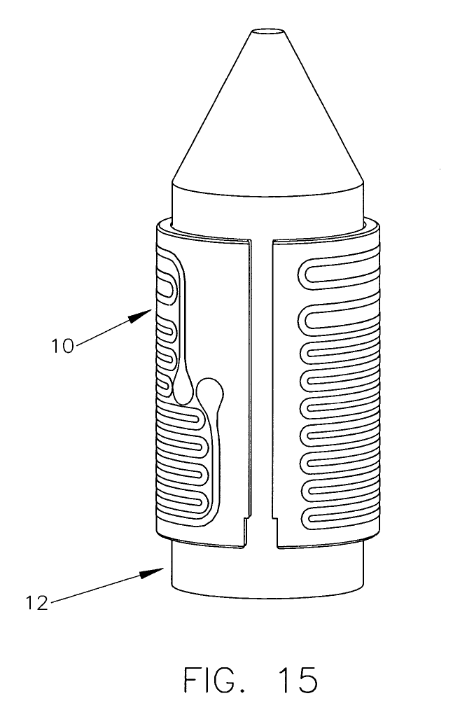

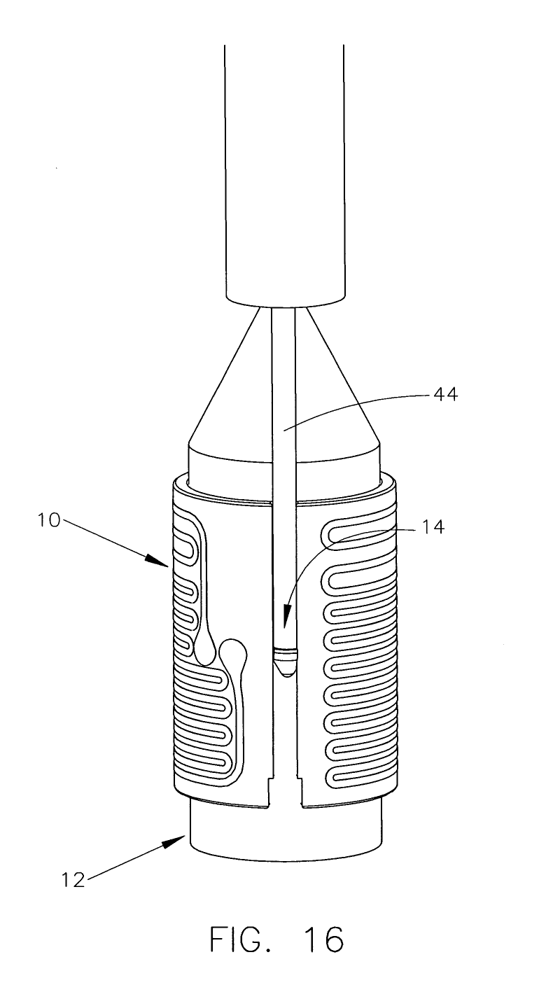

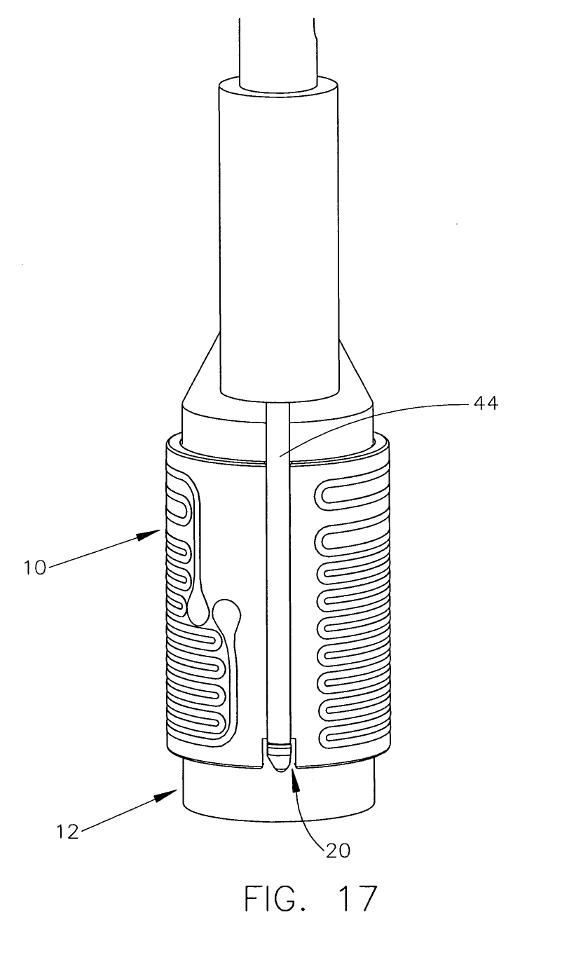

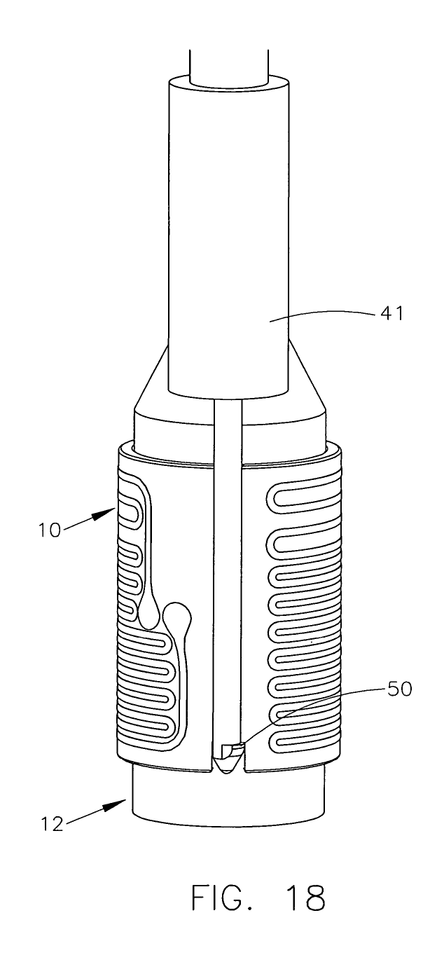

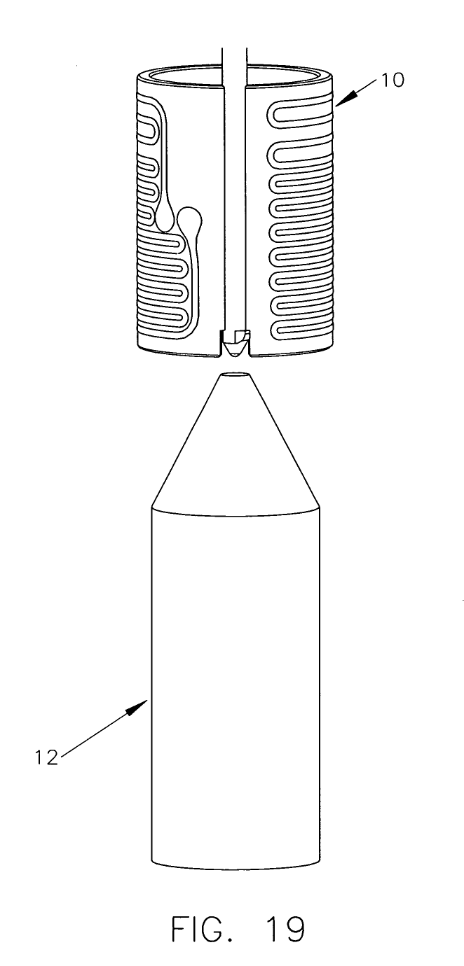

Referring now to FIGS. 15 through 19, removal of the split-sleeve heater 10 from a target object 12 is described in greater detail. The split-sleeve heater 10 is first shown disposed around the target object 12. The shaft 44 of the removal tool 40 is placed within the slot 14 with the flat face 60 positioned adjacent one curved wall 70 and the arcuate face 62 positioned adjacent the other curved wall 72 such that the protrusion 48 is positioned between the curved walls 70 and 72 proximate the exterior side of the split-sleeve heater 10 as shown. The shaft 44 is then slid down the slot 14 until the protrusion 48 is positioned within the recess 20 of the split-sleeve heater 10. The removal tool 40 is then rotated 90 degrees such that the shoulder 50 engages the recess 20 as shown. More specifically, the shoulder 50 engages the upper wall 22 of the recess.

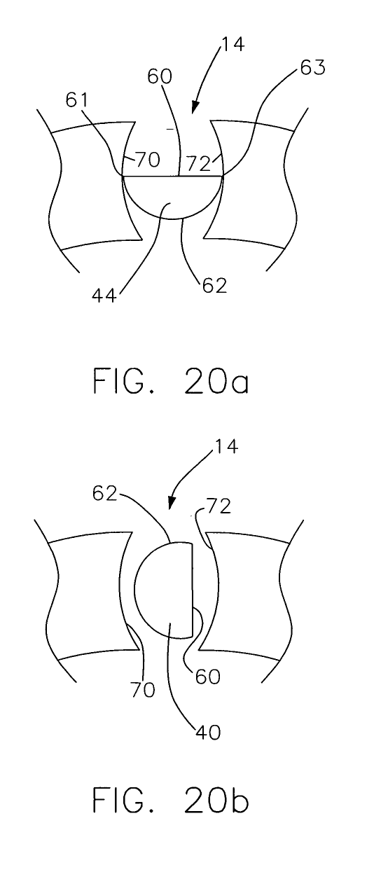

Additionally, during the rotation, the flat face 60 and the arcuate face 62 act cooperatively to spread the slot 14 apart, wherein the arcuate face 62, and edges 61 and 63, engage the curved walls 70 and 72 during the rotation. This cooperative engagement is illustrated more clearly in FIGS. 20a (engaged) and 20b (not engaged). In FIG. 20a, the shaft 44 is shown rotated 90 degrees, wherein the arcuate face 60 and the edges 61 and 63 engage the curved walls 70 and 72 to spread the slot 14 apart. When the shaft 44 is rotated back as shown in FIG. 20b, the arcuate face 60 and the edges 61 and 63 do not engage the curved walls 70 and 72, and thus the removal tool 40 is free to move in and out of the slot 14.

Next, the removal tool 40 is pulled in a proximal direction A, with the shoulder 50 engaging the upper wall 22 of the recess 20 and the slot 14 spread apart, to remove the split-sleeve heater 10 from the target object 12. After the split-sleeve heater 10 is removed from the target object 12, the removal tool 40 will remain engaged with the split-sleeve heater 10 due to the unique configuration of the slot 14 and the shaft 44. As shown in FIGS. 20a and 20b, the flat face 60 and the arcuate face 62 extend between the curved walls 70 and 72 such that the shaft 44 will remain within the slot 14 (FIG. 20a) until the shaft 44 is rotated 90 degrees (FIG. 20b) to allow for its removal.

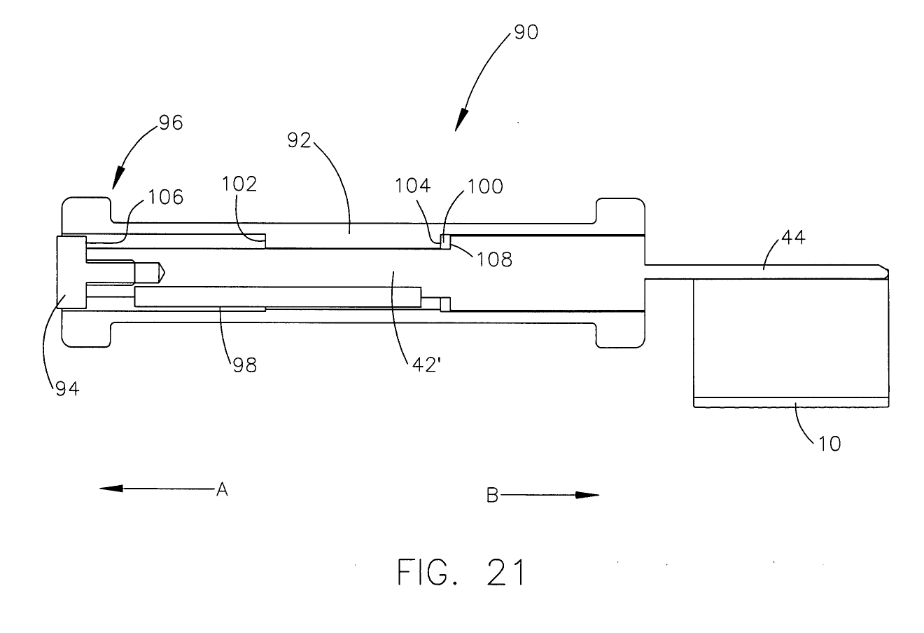

If additional force is required to pull the split-sleeve heater 10 from the target object 12, an alternate form of the present disclosure includes a slide hammer 90 operatively engaged with the handle 42′ as illustrated in FIG. 21. As shown, the slide hammer 90 comprises a body 92 extending around the handle 42′ and an extension plug 94 secured to a distal end 96 of the handle 42′. The slide hammer body 92 defines a proximal internal bore 98 and a distal internal bore 100. The proximal internal bore 98 defines an internal wall 102, and the distal internal bore 100 similarly defines an internal wall 104. The extension plug 94 defines a shoulder 106, and the handle 42′ similarly defines a shoulder 108.

In operation, the slide hammer body 92 is slid in the proximal direction A such that the internal wall 102 of the proximal internal bore 98 engages the shoulder 106 of the extension plug 94, thereby applying a force in the proximal direction A that acts on the handle 42′. The slide hammer body 92 is then slid in the distal direction B and is limited in travel by the internal wall 104 of the distal internal bore 100 engaging the shoulder 108 of the handle 42′. This sliding action is repeated until the split-sleeve heater 10 is removed from the target object 12.

Additional slide hammer configurations may also be employed while remaining within the scope of the present disclosure, such as those described in copending application Ser. No. 60/662,230, titled “Tool for Removal of a Component,” filed Mar. 16, 2005, which is commonly assigned with the present application and the contents of which are incorporated herein by reference in their entirety. Accordingly, the specific slide hammer 90 configuration as described and illustrated herein is merely exemplary and should not be construed as limiting the scope of the present disclosure as other types of slide hammers may be employed with the removal tool 40 to remove the split-sleeve heater 10 from the target object 12.

The description of the disclosure is merely exemplary in nature and, thus, variations that do not depart from the gist of the disclosure are intended to be within the scope of the present disclosure.

What is claimed is:

1. A tool for removing a split-sleeve heater from a target object comprising:
a handle;
a shaft extending from the handle, the shaft defining a distal end portion; and
a protrusion disposed around at least a portion of the distal end portion of the shaft, the protrusion adapted to engage a removal feature of the split-sleeve heater.

2. The tool according to claim 1, wherein the protrusion defines a shoulder.

3. The tool according to claim 2, wherein the shoulder extends around less than 90 degrees of a periphery of the shaft.

4. The tool according to claim 1, wherein the shaft defines a tapered end portion.

5. The tool according to claim 1, wherein the shaft defines a semi-cylindrical shape that comprises a flat face and an arcuate face joined along a length of the shaft.

6. The tool according to claim 1, further comprising a slide hammer operatively engaged with the handle.

7. A tool for removing a split-sleeve heater from a target object comprising:
a handle;
a shaft extending from the handle, the shaft defining a distal end portion; and
a protrusion disposed around at least a portion of the distal end portion of the shaft, the protrusion defining a shoulder,
wherein the shoulder is adapted to engage a removal feature of the split-sleeve heater.

8. The tool according to claim 7, wherein the shaft defines a tapered end portion.

9. The tool according to claim 7, wherein the shoulder extends around less than 90 degrees of a periphery of the shaft.

10. The tool according to claim 7, wherein the shaft defines a semi-cylindrical shape that comprises a flat face and an arcuate face joined along a length of the shaft.

11. The tool according to claim 7, further comprising a slide hammer operatively engaged with the handle.

12. A split-sleeve heater comprising:
a heater body comprising opposed ends and a slot extending between the opposed ends; and
a removal feature disposed adjacent the slot proximate at least one of the opposed ends.

13. The split-sleeve heater according to claim 12, wherein the removal feature comprises a recess formed conjointly with the slot proximate at least one of the opposed ends.

14. The split-sleeve heater according to claim 13, wherein the recess defines a rectangular configuration.

15. The split-sleeve heater according to claim 12, wherein the slot defines curved walls.

16. A method of removing a split-sleeve heater from a target object comprising:
placing a removal tool within a slot of the split-sleeve heater;
sliding the removal tool along the slot;
engaging a distal end portion of the removal tool with a recess formed conjointly with the slot; and
pulling the removal tool in a proximal direction.

17. The method according to claim 16, further comprising rotating the removal tool after sliding the removal tool along the slot to engage the distal end portion of the removal tool with the recess.

18. The method according to claim 16, wherein the pulling further comprises use of a slide hammer operatively engaged with a handle of the removal tool.

19. The method according to claim 16, wherein the target object is a hot runner nozzle body.

20. A method of forming a slot for a split-sleeve heater comprising:
placing a substrate of the split-sleeve heater around an inner mandrel, the inner mandrel defining a groove extending along a length of the inner mandrel;
placing an outer mandrel around the substrate, the outer mandrel defining a groove extending along a length of the outer mandrel;
positioning the groove of the outer mandrel opposite the groove of the inner mandrel;
placing a cutting device within the grooves of the outer mandrel and the inner mandrel; and
removing a portion of the substrate positioned between the grooves of the outer mandrel and the inner mandrel to form a slot therein.
